(19) United States
(12) Patent Application Publication
(10) Pub. No.: US 2011/0025165 A1
(43) Pub. Date: Feb. 3, 2011

(54) ROTATING ELECTRICAL MACHINE

(75) Inventors: Takashi NAGANAWA, Kasumigaura-shi (JP); Yoshihisa Ishikawa, Hitachinaka-shi (JP); Keii Ueno, Yokohama-shi (JP); Takahiro Makiyama, Hitachinaka-shi (JP); Masahiko Honma, Hitachiota-shi (JP); Yosuke Umesaki, Hitachinaka-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/845,305

(22) Filed: Jul. 28, 2010

(30) Foreign Application Priority Data
Jul. 31, 2009 (JP) 2009-178583

(51) Int. Cl. H02K 1/16

(52) U.S. Cl. 310/216.069

(57) ABSTRACT

A rotating electrical machine including a rotor in which a plurality of magnetic poles are provided in circumferential direction, and a stator within the rotor is disposed with a gap against the rotor, wherein: coil groups are received in a slot between two teeth of the stator core; each of the teeth has a tooth main body and two tooth tip edge portions, and the tooth main body and the tooth tip edge portions are connected by connecting portions, with slits being formed in the coil sides of the connecting portions; and the slits extend from opening portions towards the centers of the tooth tip edge portions in circumferential direction, and are formed so that their tooth main body sides and their tip edge portion sides, that together define the opening portions of the slits, contact one another; with the gaps between adjacent ones of the tooth tip edge portions in circumferential direction being smaller than a width of the slot.

### INCORPORATION BY REFERENCE

The disclosure of the following priority application is herein incorporated by reference: Japanese Patent Application No. 2009-178583 filed Jul. 31, 2009.

### BACKGROUND OF THE INVENTION

1. Field of the Invention

The present invention relates to a rotating electrical machine.

2. Description of the Related Art

The methods of distributed winding and concentrated winding and so on are per se known as methods for constructing the stator coils of a rotating electrical machine. Among these, from the point of view of reduction of iron loss, it is desirable for the stator core of a distributed winding coil to be of the integrated type. Furthermore, from the point of view of reduction of iron loss, it is desirable for the widths of the tip portions of the teeth of the stator core to be wider than the widths of the slots in the stator core upon which the coils are wound, in other words, for the gaps between adjacent ones of the teeth to be narrowed down.

During manufacture, it is necessary to form the wirings to straddle the slots of the stator core, and, in order to fit the successive wirings into the slots from the radially interior side of the stator core, it is preferable for these gaps between adjacent teeth to be broad. Thus the wires are assembled to the stator core in a state in which the gaps between its teeth (i.e. the slots) are broad, and then, after fitting the wires, the spaces between the teeth are narrowed down, in other words the widths of the end portions of the teeth of the stator core are widened; and this furnishes the advantages of facilitating manufacture and enhancing the resultant performance.

A method is per se known of forming an armature that rotates along with coils wound thereupon, in which the ends of the core teeth are formed after assembly of the wiring to the core (refer to Japanese Laid-Open Patent Publication H03-273850).

### SUMMARY OF THE INVENTION

In the light of current energy problems, there are great demands for increase of the efficiency of rotating electrical machines. However, since the technique described above is an armature in which the coil side rotates, the end portions of the teeth of the rotor core are disposed upon its external circumference, in other words the slots face radially outwards.

Accordingly, an object of the present invention is to provide a rotating electrical machine that is compact, in which the coil side is the stator, and in which the distributed winding coils are stored satisfactorily within the stator slots from the interior side of the stator core.

According to the 1st aspect of the present invention, a rotating electrical machine comprises a rotor in which a plurality of magnetic poles are provided in circumferential direction, and a stator within the rotor is disposed with a gap against the rotor, wherein: coil groups are received in a slot between two teeth of the stator core; each of the teeth has a tooth main body and two tooth tip edge portions, and the tooth main body and the tooth tip edge portions are connected by connecting portions, with slits being formed in the coil sides of the connecting portions; and the slits extend from opening portions towards the centers of the tooth tip edge portions in circumferential direction, and are formed so that their tooth main body sides and their tip edge portion sides, that together define the opening portions of the slits, contact one another; with the gaps between adjacent ones of the tooth tip edge portions in circumferential direction being smaller than a width of the slot.

According to the 2nd aspect of the present invention, in a rotating electrical machine according to the 1st aspect, it is preferred that the width of the opening portion is smaller than the thickness of one of laminated members included in the stator core.

According to the 3rd aspect of the present invention, in a rotating electrical machine according to the 1st aspect, it is preferred that, before expand shaping of the tooth tip edge portions, the widths of the tooth tip edge portions in circumferential direction are less than the widths of the tooth main body, and the tooth tip edge portions are shaped by expanding in the state in which the coil group is held in the slot of the stator core, the widths of the tooth tip edge portions in circumferential direction are greater than the widths of the tooth main body.

According to the 4th aspect of the present invention, a rotating electrical machine comprises a rotor in which a plurality of magnetic poles are provided in circumferential direction, and a stator within the rotor is disposed with a gap against the rotor, wherein: coil groups are received in a slot between two teeth of the stator core; each of the teeth has a tooth main body and two tooth tip edge portions, and the tooth main body and the tooth tip edge portions are connected by connecting portions, with slits being formed in the coil sides of the connecting portions; and the slits extend from opening portions towards the center of the stator core in the radial direction and also towards the centers of the tooth tip edge portions in circumferential direction, and are formed so that their tooth main body sides and their tip edge portion sides, that together define the opening portions of the slits, contact one another; with the gaps between adjacent ones of the tooth tip edge portions in circumferential direction being smaller than the widths of the coil groups in circumferential direction.

With this rotating electrical machine, while maintaining the advantage of a distributed winding stator of possessing excellent rotational characteristics, it is also possible to anticipate improvement of the space factor of the coils within the core slots.

### BRIEF DESCRIPTION OF THE DRAWINGS

FIG. 1 is an elevation view of a stator of a rotating electrical machine that is an embodiment of the present invention;

FIG. 2A and FIG. 2B are enlarged sectional views of slot portions of this stator of a rotating electrical machine that is an embodiment of the present invention;

FIG. 3A and 3B are enlarged sectional views of one of these slot portions of this rotating electrical machine that is an embodiment of the present invention, showing a process of insertion of wire members into this slot;

FIG. 4A and FIG. 4B are enlarged sectional views of this slot portion of this rotating electrical machine that is an embodiment of the present invention, showing a first process stage in which the ends of the teeth of the stator core are open molded into intermediate shapes;

FIG. 5A and FIG. 5B are enlarged sectional views of this slot portion of this rotating electrical machine that is an embodiment of the present invention, showing a second process stage in which the ends of the teeth of the stator core are shaped by expanding into their final shapes;

FIG. 6A and FIG. 6B are sectional views of this slot portion of this rotating electrical machine that is an embodiment of the present invention, taken in the axial direction and showing these processes of expand shaping of the teeth tip of the stator core;

FIG. 7 is an enlarged sectional view of a slot portion of a rotating electrical machine that is another embodiment of the present invention, and shows wire members being inserted into this slot portion;

FIG. 8 is an enlarged sectional view of this slot portion of a rotating electrical machine that is another embodiment of the present invention, showing its configuration after the expand shaping process has been completed;

FIG. 9 is a conceptual figure showing a rotating electrical machine according to an embodiment of the present invention;

FIG. 10 is a conceptual figure showing a rotating electrical machine according to another embodiment of the present invention;

FIG. 11 is a sectional view of an air cooled type AC generator 100 for a vehicle, according to an embodiment of the present invention; and

FIG. 12A and FIG. 12B show three-phase rectification circuits suitable for the windings shown in FIG. 11.

### DESCRIPTION OF THE PREFERRED EMBODIMENTS

The embodiments explained below are related to a rotating electrical machine such as a motor or a generator or the like and to a method of manufacture thereof, and particularly relate to a rotating electrical machine that is provided with a stator core whose slots are formed to be semi-closed by expand shaping of the ends of its teeth.

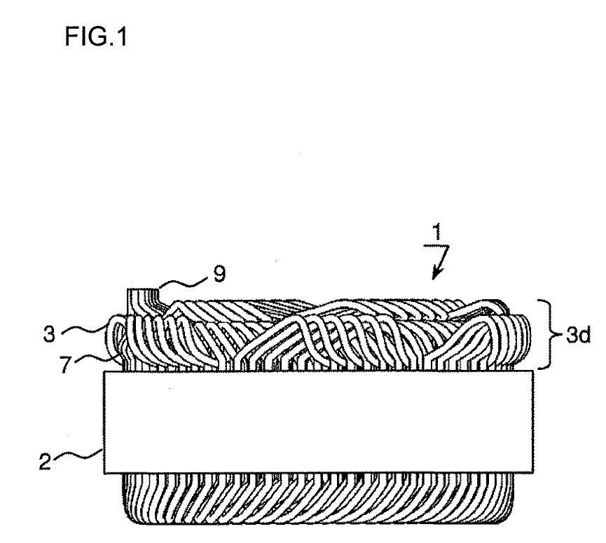

FIG. 1 shows a stator coil 1 of a rotating electrical machine that is an embodiment of the present invention. A coil is wound upon this stator 1 so that two stator magnetic poles created by coil turns in phase are disposed within an electrical angle of 360° defined by the magnetic poles of a rotor used with this stator 1. The details of this dispersal winding coil will be described hereinafter.

FIG. 1 is an elevation view of this stator 1 as seen from the side of its stator core 2, and shows a dispersal winding coil 7 installed upon the stator core 2, and wires 3 connected to a terminal portion 9. With this structure, the height of the coil end portion 3d becomes low.

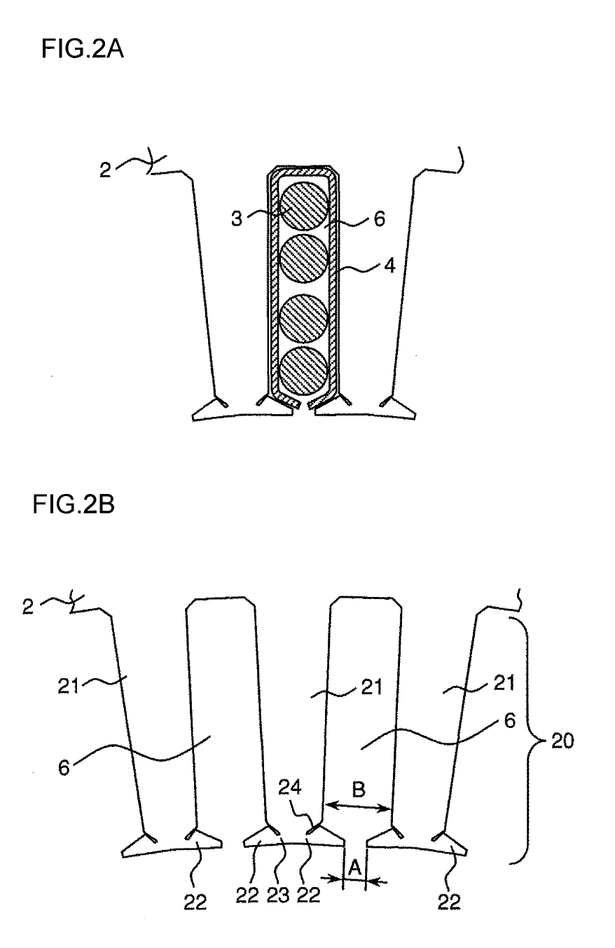

FIG. 2 gives two enlarged sectional views of stator core slots 6 in the stator core 2.

FIG. 2A is a sectional view showing insulating paper 3 and wires 3 in the installed state; the stator core 2 is made from silicon steel plate of thickness around 0.35 mm or the like by die cutting and lamination. The wires 3 are metallic wires having an insulating covering layer, and, in this embodiment, they are made by covering conductors made from copper with polyamide-imide resin. These wires 3 bearing their insulating cover layers are disposed in the stator core slot 6 of the stator core 2. By the wires 3 being received within a further layer of insulating material 4, their insulation is improved. Holding the wires 3 with the insulating paper 4 serves as a countermeasure for ensuring insulation against any pin holes that may by an unlikely chance be present in the resin enamel cover layer that covers the surface of the wires 3, and also serves to prevent damage to the resin enamel cover layer during installation of the wires 3 upon the stator core. The wires 3 in this figure are round circular wires whose cross section is circular, and a construction is adopted in which four of these wires 3 are disposed along the axial direction of the stator core slot 6 of the stator core 2.

FIG. 2B is an enlarged view of three of the teeth of the stator core 2 and the two slots 6 between them, with the insulating paper 4 and the wires 3 omitted.

Each tooth 20 has a tooth main body 21 and two tooth tip edge portions 22, and the tooth main body 21 and the tooth tip edge portions 22 are connected together by connecting portions 23. Moreover slits 24 are formed in the sides of the connecting portions 23 where the coils are held, and these slits 24 extend from their opening portions towards the centers of the tooth tip edge portions 22 in the circumferential direction, with a portion on the tooth main body 21 that defines the opening portion of the slit 24 and a portion of the tip edge portion 22 being formed so as to contact one another, and with the gaps A in the circumferential direction between the edges of adjacent ones of the tooth tip edge portions 22 being formed to be smaller than the width B of the slots. This stator having a semi-closed slot construction is formed in this manner.

Furthermore, it is preferred that the width of the opening portion of the slit 24 is smaller than, for example, the thickness of a silicon steel plate of the laminated in the stator core.

A magnet rotor (not shown in the drawings) or a squirrel-cage type copper rotor (also not shown) is installed coaxially in the interior of this stator 1, and the two ends of this rotor are rotatably supported in bearings, so as to constitute an electric motor or a generator.

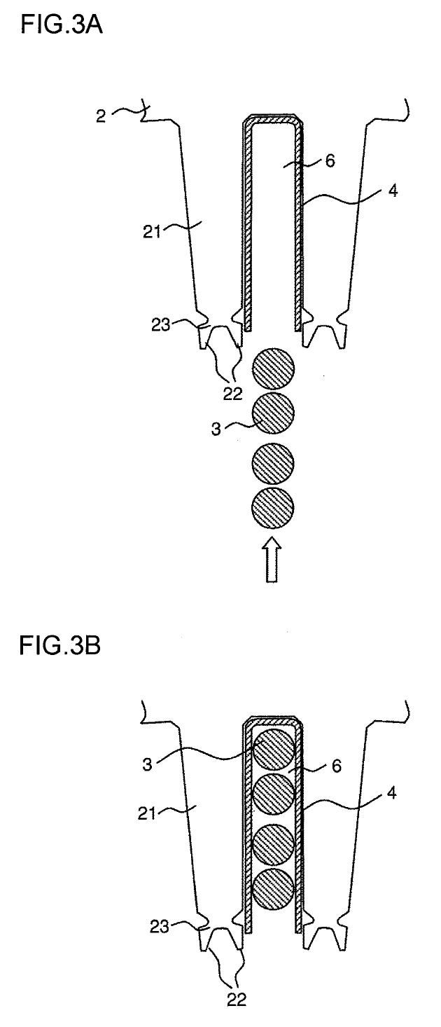

FIG. 3 includes two enlarged sectional views of one of these slots 6 of the stator core 2, and shows a process whereby the wires 3 are inserted into this slot 6. FIG. 3A shows the situation before the wires 3 are inserted into the slot 6 of the stator core 2. The depth from the tooth tip edge portions 23 to the bottom of the slot 6 is sufficiently great to accommodate the number of the wires 3 to be fitted thereinto (four in this case), while the width between the two tooth tip edge portions 22 is sufficiently great to pass the wires 3. The insulating paper 4 is disposed within the slot 6. And FIG. 3 shows the situation after the wires 3 have been inserted into the slot 6 in the stator core 2. The wires 3 are disposed within the slot 6, enfolded in the insulating paper 4.

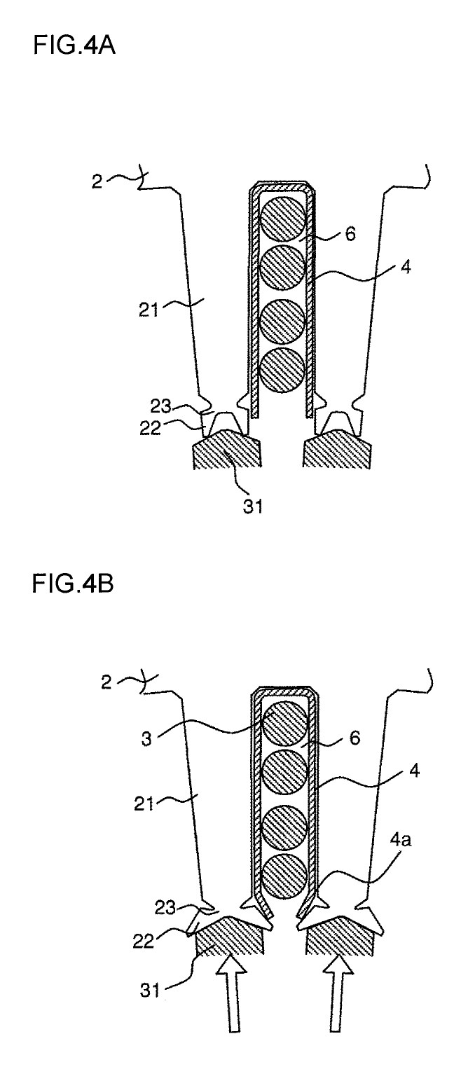

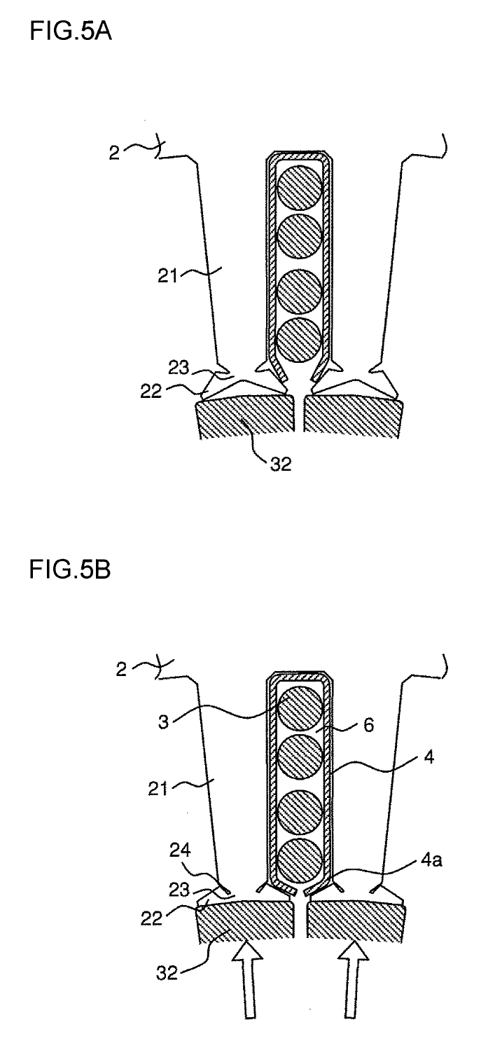

Each of FIGS. 4 and 5 includes two enlarged sectional views of this slot portion. First, as shown in FIG. 4A, a punch 31 for expand shaping is disposed on the radially inward side of the stator core 2, into the slot 6 of which the wires 3 have been inserted, opposing the tooth 21. Next, as shown by the arrow signs in FIG. 4B, the punch 31 is shifted in the radially outward direction from the interior of the stator core, and performs a first stage of expand shaping the tooth tip edge portions 22 by pushing them apart from one another to a certain extent. Next the punch is changed, and another punch 32 with larger width for further expand shaping, is disposed on the radially inward side of the stator core 2, as shown in FIG. 5A. And then, as shown by the arrow signs in FIG. 5B, the punch 32 is shifted in the radially outward direction from the interior of the stator core, and performs a second stage of expand shaping the tooth tip edge portions 22 by pushing them apart further into their final shapes.

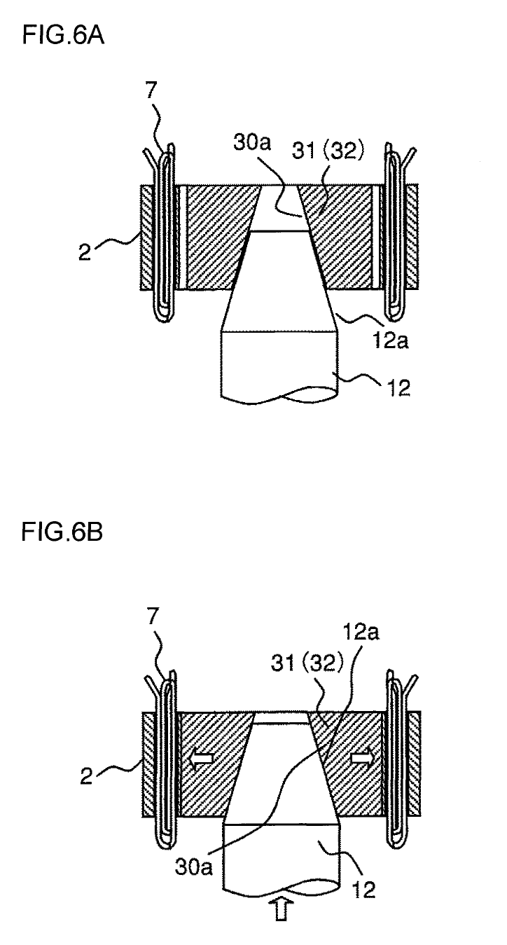

FIG. 6 includes two sectional views that schematically show this process for expand shaping of the ends of the stator teeth 20. FIG. 6A shows the situation before the punches 31 or 32 are pushed outwards. Actually, a plurality of punches 31 (32), which are of the same number of slots, are fitted into respective slots, and a pressurization rod 12 is installed under these punches 31 (32). Furthermore, taper portions 30a are formed upon the punches 31 (32), and a taper portion 12a is formed upon the pressurization rod 12. FIG. 6B shows the situation when the punches 31 (32) have been pushed radially outwards. By shifting the pressurization rod 12 in the upwards direction in the drawing, the punches 31 (32) are shifted in the radially outward direction into the slots in the stator core 2 by the pressurization rod taper portion 12a and the punch taper portions 30a, so that the tool tip edge portions 22 are shaped by expanding.

The stator shown in FIG. 1 is formed by performing the procedure described above, with the dispersal winding coil assembled thereupon.

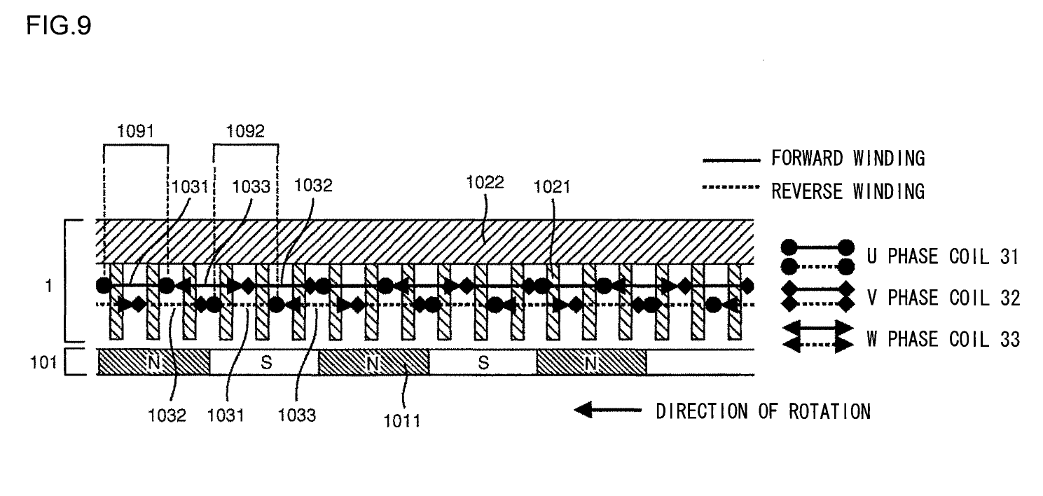

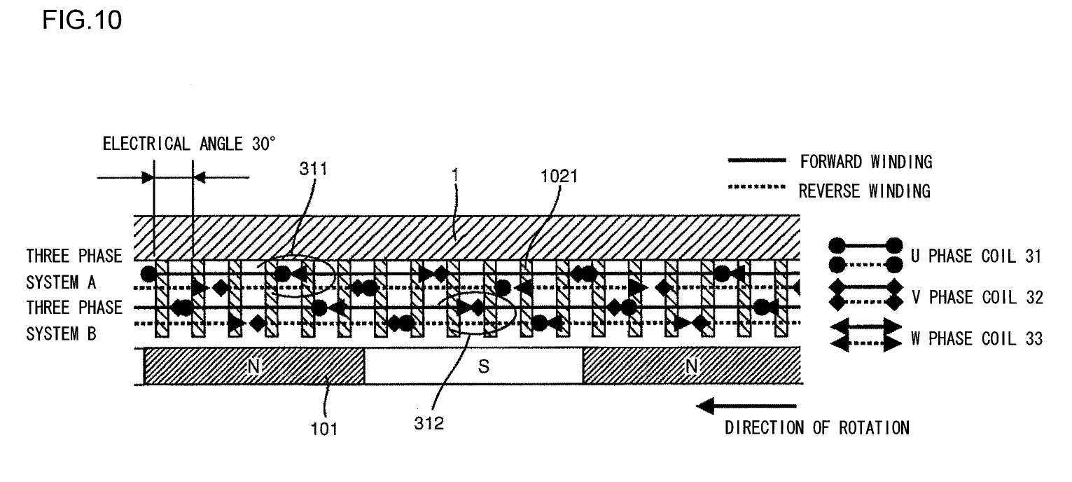

The details of the dispersal winding coil will now be explained using FIGS. 9 and 10.

FIG. 9 is a conceptual figure showing a rotating electrical machine that is an embodiment of the present invention. This figure shows a portion of the rotating electrical machine developed into a linear format.

The rotating electrical machine is constituted with a rotor 101 and a stator 1, and the rotor 101 has a plurality of rotor magnetic poles 1011 and the stator 1 is provided with a plurality of teeth 1021 that constitute stator magnetic poles, with U-phase coils 1031, V-phase coils 1032, and W-phase coils 1033 being wound upon these teeth 1021. Here, the V-phase coils are defined as being coils in which AC current flows having a phase that is delayed by 120° (i.e. is advanced by 240°) with respect to the AC current that flows in the U-phase coils. Furthermore, the W-phase coils are defined as being coils in which AC current flows having a phase that is delayed by 240° (i.e. is advanced by 120°) with respect to the AC current that flows in the U-phase coils. The rotational direction of the rotor 1 is shown in FIGS. 9 and 10 by arrow signs.

The solid lines mean that the corresponding coils are wound forward (the wire is wound upon the teeth in the clockwise direction as seen from the radial interior), while the dotted lines mean that the corresponding coils are wound in the opposite direction (the wire is wound upon the teeth in the anti-clockwise direction as seen from the radial interior). While in FIG. 1 a case is shown in which the forward wound coils are wound in the positions more remote from the rotor, it would also be acceptable for them to be wound in the positions closer to the rotor. In the stator coil structure of this embodiment shown in these figures, two concentrated winding coils are arranged as superimposed upon one another in such positions that their electrical angles are deviated from one another by 180°, and their respective U-phase coils, V-phase coils, and W-phase coils are connected in series. To put it in another manner, this is a rotating electrical machine in which the rotor 1 is disposed within a vacant space within the stator 1, and the coils are wound so that the two stator magnetic poles 1091, 1092 created by turns of the coils in phase are disposed within a region having electrical angle width of 360°, the angular width in the circumferential direction of the coils that form each of these stator magnetic poles 1091, 1092 is less than the electrical angle width of 180°, and the coils that form these stator magnetic poles 1091, 1092 are provided so as not to be mutually overlapped; and, moreover, the coils are wound so that the two stator magnetic poles 1091 and 1092 have mutually opposite polarity. Here, the coils that create the two stator magnetic poles 1091, 1092 are provided as being mutually spaced apart by 180° of electrical angle. And the three stator magnetic poles for the U, V, and W phases are arranged so as to be mutually spaced apart by 60° of electrical angle. It should be understood that the V-phase coil is wound oppositely to the U-phase coil. Due to this, since +60°−180°=−120°, the V-phase coil is delayed in phase by 120° with respect to the U-phase coil. Furthermore, since the W-phase coil is wound in the same orientation as the U-phase coil, it is advanced in phase by 2×60°=120° with respect to the U-phase coil. Moreover, in this embodiment, the electrical angle width over one coil is 120°, so that, for the same phase, two coils are wound over a region of 240° electrical angle, in other words are wound over ⅔ of the entire number of teeth. This type of coil winding is termed dispersal winding.

Due to this coil structure, with the stator coil according to this embodiment, the extending circuit area of coils of each phase to which the magnetic flux of the rotor interlinks is twice as great as compared with a concentrated winding coil construction in which a single concentrated winding coil is provided within 360° of electrical angle, so that the efficiency of utilization of the coil is twice as great as with a concentrated winding. Since the same interlinkage magnetic flux is obtained as with a concentrated winding, accordingly, if some single tooth is considered, in this embodiment, half of the number of coil turns wound around the teeth will suffice, as compared with the case of a concentrated winding. The coils for the U-phase, the V-phase, and the W-phase are decentralized twice as much as compared with the case of a concentrated winding, and moreover, in this construction, the coils are not wound upon all of the teeth as with the case of a distributed winding; rather, the coils are only wound upon ⅔ of the total number of teeth. Due to this it is possible to keep the coil inductance low, as compared with the case of a concentrated winding or of a distributed winding.

Furthermore since in this embodiment, as compared with the case of a concentrated winding, the coils are arranged so as to be distributed in a twice wider area, and also the U-phase coil, the V-phase coil, and the W-phase coil are so placed that they are approximately half overlapped to each other, accordingly reverse action upon the armature is distributed comparatively uniformly in the circumferential direction as compared with the case of a concentrated winding, so that, with this construction, the higher order harmonic component of electromagnetic force is reduced. Due to this, it is possible for this rotating electrical machine to function more quietly, as compared with the case of a concentrated winding.

Although the example of FIG. 9 is a construction in which one stator tooth is provided for each 60° of electrical angle, and the coil turns are wound with widths of 120° of electrical angle, it should be understood that it would also be possible to obtain similar beneficial effects with a construction in which one stator tooth is provided for each 30° of electrical angle, and the coil turns are wound with electrical angle widths of 90°, or 120°, or 150°.

FIG. 10 is a conceptual figure showing another rotating electrical machine according to an embodiment of the present invention. The features thereof other than those described below are the same as in the embodiment described above.

In this embodiment, a construction is adopted in which the dispersal winding construction described above and a double three phase construction are combined. In other words, two of the winding groups shown in FIG. 9 are provided, and they are configured so that their phases are mutually shifted. As shown in FIG. 10, in this construction, the number of teeth 1021 is 12 for 360° of electrical angle, and the electrical angle phase shift between adjacent teeth is 30°. On portions of the teeth 1021 that are more outward in the radial direction, three-phase AC system coils are provided in a dispersal winding construction for one single three-phase AC system (three phase system A); and moreover, on portions of the teeth 1021 that are more inward in the radial direction, three-phase AC system coils are provided in a dispersal winding construction for another single three-phase AC system (three phase system B). The three phase system B is displaced by an electrical angle of 30° with respect to the three phase system A, and is connected in parallel therewith. In both of the three phase systems A and B, the coils are wound around, for example, four teeth.

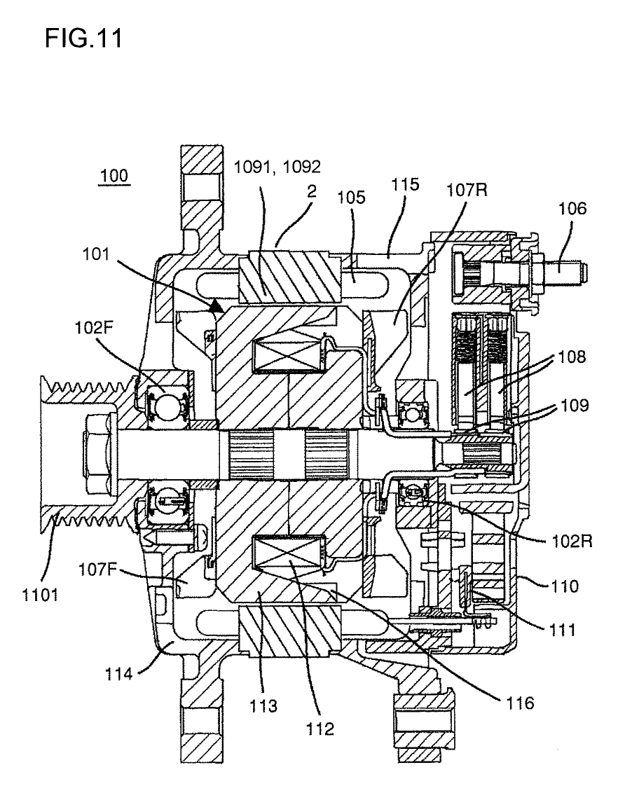

FIG. 11 is a sectional view of an air cooled type AC generator 100 for a vehicle according to an embodiment of the present invention. A claw shaped magnetic poles 113 are provided outward around the shaft of a rotor 1, and a field coil 112 is disposed in the midst within these poles 113. A pulley 1101 is fixed to the end of the shaft, and slip rings 109 are provided at the opposite end thereof for supplying electricity to the field coil 112. Furthermore, a front cooling fan 107F and a rear cooling fan 107R are provided to the rotor 1 at the two end surfaces of the claw shaped magnetic pole 113, and these fans 107F, 107R rotate along with the rotor 1. Moreover, a plurality of permanent magnets 116 that are provided to the claw shaped magnetic poles 113 serves the purpose of auxiliary excitation in order to give an additional magnetic flux to the field coil magnetic flux. On the other hand, a stator 1 comprises stator magnetic poles 1091, 1092 and stator windings, and is disposed so as to oppose the rotor 1 with a slight gap between them. The stator 1 is supported by a front bracket 114 and a rear bracket 115, with the rotor 1 being rotatably supported by these brackets 114 and 115 via respective bearings 102F and 102R. The slip rings 109 described above are contacted against brushes 108, and thereby electrical power is supplied to the rotor 1. And the stator winding is built as a three state winding according to the embodiment described above, with the lead wires of each of its windings being connected to a rectification circuit 111. This rectification circuit 111 comprises rectification elements such as diodes or the like, and is built as a full wave rectification circuit. For example, in the case of diodes, their cathode side terminals are connected to a terminal 106. Moreover, their anode side terminals are electrically connected to the main body of this vehicle AC generator. Finally, a rear cover 110 serves the role of covering over and protecting the rectification circuit 111.

Next, the operation of this generator as it generates electricity will be explained. Usually an engine (not shown in the figures) and such a vehicle AC generator 100 are connected by a belt (also not shown). The vehicle AC generator is connected to the engine by the pulley 1101 and a belt, so that its rotor 1 rotates together with the rotation of the engine. By an electrical current being flowed in the field coils 112 that are provided at the central portion of the claw shaped magnetic pole 113 of the rotor 1, these claw shaped magnetic poles 113 are magnetized, and, due to the rotation of the claw poles 113, three phases of induced electromotive force are thereby generated in the stator coils. These voltages are full wave rectified by the rectification circuit 111 described above, and thereby a DC voltage is generated. The positive side of this DC voltage is connected to the terminal 106, and furthermore this terminal 106 is connected to a battery (not shown in the figures). The field magnet current is controlled so that the DC voltage after rectification becomes equal to a voltage that is suitable for charging the battery; the details of this arrangement are omitted.

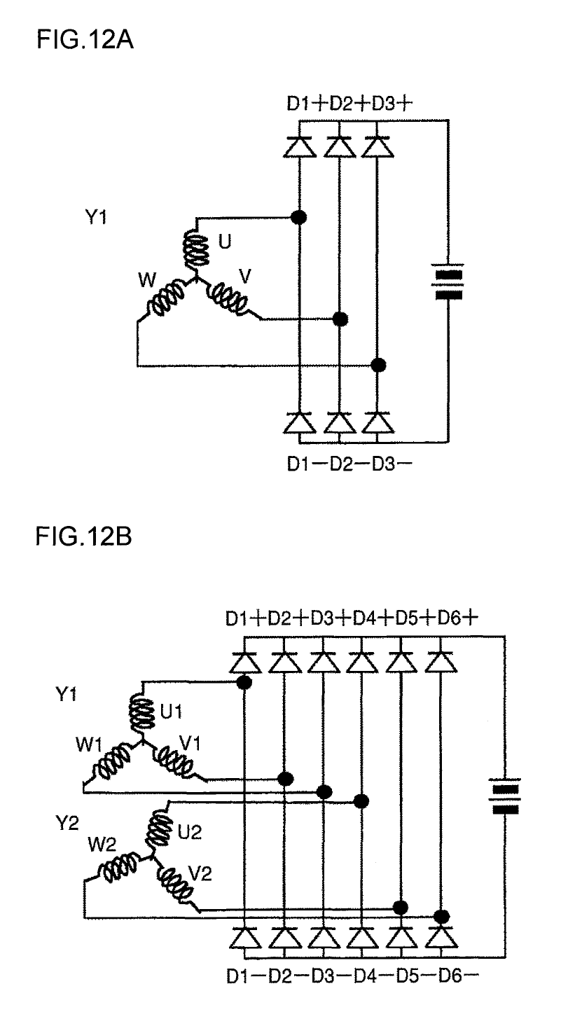

FIG. 12 shows two three-phase rectification circuits that are suitable for use with the windings shown in FIG. 11 and described above. FIG. 12A corresponds to the embodiment of FIG. 9, while FIG. 12B corresponds to the embodiment of FIG. 10. In each case, the coils for the three phases are connected in a three phase star connection. The terminals at the sides of the three phase coils having opposite polarity to their mutual connection point are connected to six diodes D1+. . . D3−, as shown in the figures. Furthermore, the cathodes of the diodes on the positive side are connected together, and are connected to the positive terminal of the battery. In a similar manner, the anodes of the diodes on the negative side are connected together, and are connected to the negative terminal of the battery.

In FIG. 12B, the voltages of the U1 winding and the U2 winding of the three phase winding, that are electrically independent, are equal, but their phases are different by 30°, and a voltage of larger one of these two voltages is adopted in effect, so that the voltage finally carries a ripple of 30° in width.

It should be understood that, while here an example of a star connection is shown, it would also be acceptable to employ a delta connection. If such a delta connection is employed, then the beneficial effect is obtained that it is possible to enhance the induced voltages in the coils by 11.5% as compared to the case of a star connection.

It should be understood that the embodiment described above, or, to put it in another manner, this rotating electrical machine that has stator coils in which a single three phase AC electrical current flows, teeth upon which this coil is wound, a stator that includes these teeth and the base part of the stator core for returning the magnetic flux flowing in the teeth, and a rotor that has magnetic poles opposing the teeth, may be a rotating electrical machine in which the stator coils that are wound upon the teeth are only a U-phase coil and a V-phase coil, or only a V-phase coil and a W-phase coil, or only a W-phase coil and a U-phase coil.

Furthermore, a rotating electrical machine that comprises stator coils in which a single three phase AC electrical current flows in each coil, teeth upon which this coil is wound, a stator that includes these teeth and the base part of the stator core for returning the magnetic flux flowing in the teeth, and a rotor that has magnetic poles opposing the teeth, and in which the U-phase coils, the V-phase coils, and the W-phase coils each in a concentrated winding coil arrangement are disposed radially outward in the teeth, and in which the U-phase coils, the V-phase coils, and the W-phase coils each in a concentrated winding with reversed winding direction are disposed radially inward, and, for each phase, the coils including the reversely wound coils are connected in series.

Yet further, this rotating electrical machine may be a rotating electrical machine that has two three-phase coil systems comprising a U-phase coil, a V-phase coil, and a W-phase coil, and in which the electrical angle phase differences between the coil systems are set to around 30°, or within the range from 20° to 40°.

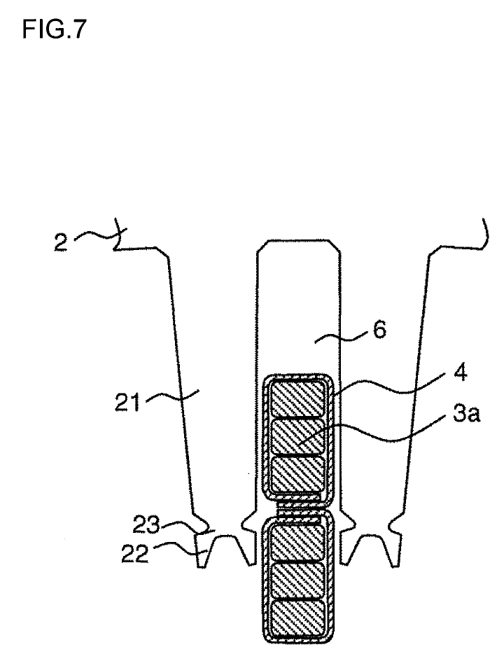

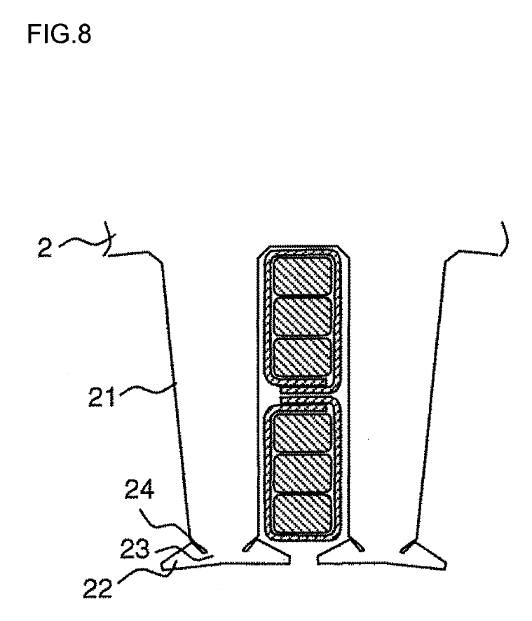

It should be understood that, while this embodiment has been explained in terms of a dispersal winding coil, it could be a coil wound by any winding method, such as a distributed winding coil or a concentrated winding coil or the like. Such a variant embodiment will now be explained with reference to FIGS. 7 and 8. FIGS. 7 and 8 show an embodiment when a coil is made with wires 3a whose cross sectional shape is generally rectangular: these are enlarged sectional views of a portion that includes a slot 6, showing a case in which a coil is used that is wound outside the core 2, and is wrapped in insulating paper 4. FIG. 7 shows a state in which the wires 3a are being inserted into the slot 6. After the wires 3a have been inserted into the slot 6, the stator core 2 shown in FIG. 8 is obtained by performing expand shaping upon the tooth tip edge portions 22, using the same process as that explained above with reference to FIGS. 4 through 6.

The above described embodiments are examples, and various modifications can be made without departing from the scope of the invention.

What is claimed is:

1. A rotating electrical machine comprising a rotor in which a plurality of magnetic poles are provided in circumferential direction, and a stator within the rotor is disposed with a gap against the rotor, wherein:
coil groups are received in a slot between two teeth of the stator core;
each of the teeth has a tooth main body and two tooth tip edge portions, and the tooth main body and the tooth tip edge portions are connected by connecting portions, with slits being formed in the coil sides of the connecting portions; and
the slits extend from opening portions towards the centers of the tooth tip edge portions in circumferential direction, and are formed so that their tooth main body sides and their tip edge portion sides, that together define the opening portions of the slits, contact one another; with the gaps between adjacent ones of the tooth tip edge portions in circumferential direction being smaller than a width of the coil groups in circumferential direction.

2. A rotating electrical machine according to claim 1, wherein the width of the opening portion is smaller than the thickness of one of laminated members included in the stator core.

3. A rotating electrical machine according to claim 1, wherein, before expand shaping of the tooth tip edge portions, the widths of the tooth tip edge portions in circumferential direction are less than the widths of the tooth main body, and the tooth tip edge portions are shaped by expanding in the state in which the coil group is held in the slot of the stator core, the widths of the tooth tip edge portions in circumferential direction are greater than the widths of the tooth main body.

4. A rotating electrical machine comprising a rotor in which a plurality of magnetic poles are provided in circumferential direction, and a stator within the rotor is disposed with a gap against the rotor, wherein:
coil groups are received in a slot between two teeth of the stator core;
each of the teeth has a tooth main body and two tooth tip edge portions, and the tooth main body and the tooth tip edge portions are connected by connecting portions, with slits being formed in the coil sides of the connecting portions; and
the slits extend from opening portions towards the center of the stator core in the radial direction and also towards the centers of the tooth tip edge portions in circumferential direction, and are formed so that their tooth main body sides and their tip edge portion sides, that together define the opening portions of the slits, contact one another; with the gaps between adjacent ones of the tooth tip edge portions in circumferential direction being smaller than the widths of the coil groups in circumferential direction.
